(19) United States
(12) Patent Application Publication
(10) Pub. No.: US 2003/0147682 A1
(43) Pub. Date: Aug. 7, 2003

(54) System and methods for real-time printing

(76) Inventors: Samuel M. Lester, Boise, ID (US); Jimmy Sfaelos, Eagle, ID (US)

Correspondence Address: HEWLETT-PACKARD COMPANY, Intellectual Property Administration, P.O. Box 272400, Fort Collins, CO, 80527-2400, US

(21) Appl. No.: 10/072,706

(22) Filed: Feb. 5, 2002

(51) Int. Cl. B41J 11/44

(52) U.S. Cl. 400/76

(57) ABSTRACT

The system and methods described herein relate to printing a document in real-time. That is, upon activation of a print command, a printing device can immediately begin moving print media and output printed material. Rather than requiring printing resources to process a document all at once, the system and methods spread processing demands out over the duration of the document's composition. Advantages of the disclosed system and methods include reduced or nonexistent delay times between the activation of a print command and the initiation of printed output and a reduction in printing failures.

### TECHNICAL FIELD

The present disclosure relates to document printing, and more particularly, to pre-processing document information during the generation of a document so that a printing device can begin outputting printed material directly upon receiving a print instruction.

### BACKGROUND

Customer satisfaction with printing devices depends almost exclusively on printing performance. Next to print quality, the speed with which a printing device produces a document is perhaps the most important performance factor to influence customer satisfaction. Most users composing a document on a computer within an application program expect a printing device to begin printing the document without delay once the user activates the “print” command from within the application program. However, conventional methods of processing document information prevent printing devices from outputting a printed document directly upon user-activation of the print command. An inherent delay exists that extends from the moment a user activates a print command from within an application to the moment the printing device begins moving print media to print a page. The larger and more data-intensive a document is, the longer the delay will be. This delay reflects poorly on printing performance and tends to reduce a user's satisfaction with a printing device.

In general, documents are created or composed on a computer within an application program in a “language” that the application understands. When a user activates a print command within the application, printer driver software associated with a printer normalizes the communication between the application and the driver software so that the driver software can convert a document into a language that the printer understands. The language understood by the printer is a page description language (PDL) such as Printer Control Language (PCL) or PostScript.

Converting the application document from the application's language into the printer's language changes the document into a file often called a print job. Once the print job is created, it is transferred as streaming data to the associated printer. The print job is rendered into raster bits as it streams into the printer. The raster bits drive a print engine to lay down dots or pixels onto a print medium (e.g., a page of paper) in a pattern that matches the pattern of the document composed within the application program.

In addition to the inherent printing delay discussed above, there are other performance-related problems associated with current printing methods that can reduce a user's satisfaction with a printing device. Current printing methods do not process an application document for printing until a user activates a print command from within an application program. Activation of a print command typically occurs once a user has completely finished the document. Therefore, print jobs sent to printing devices tend to represent an entire document rather than just portions of a document. Depending on the size of a document, the activation of a print command can place a sudden and extreme demand on printing resources. This sudden demand on printer resources can cause printing failures such as “memory out” and “page too complex” failures.

A “memory out” failure can occur as a print job is streaming into a printing device from, for example, a networked computer. A printer with a small memory may run out of memory in the middle of processing a particularly large page of a print job. If this happens, the printer has no way to go back and execute techniques such as a data compression technique that might otherwise permit the large page to be printed. Rather, the printer prints whatever portion of the page that it has processed from the streaming print job and then issues a “memory out” error.

A “page too complex” failure can occur if print job data streaming into the printer is not rendered fast enough as raster bits to keep up with the print engine. This type of failure relates in part to printer hardware speed and/or the speed of the network over which the print job is being transferred. Generally however, both the “memory out” failure and the “page too complex” failure relate to the sudden need for a printing device to process large amounts of data all at once.

Printer manufacturers try to alleviate the above problems using various techniques. For example, printer manufacturers introduce mechanisms into printing devices that lead a user to believe that there is little or no delay between the activation of a print command and the beginning of document printing by the printer. These mechanisms can include turning on printer lights or displaying a control panel message indicating the printer is warming up directly upon activation of a print command. Thus, users have a greater sense of satisfaction because they perceive that printers begin printing right when the print command is activated. However, these mechanisms only hide the processing delay inherent to current printing methods. They do not fix the delay.

In order to actually reduce the problems noted above that are associated with the sudden demands placed on printer resources, printer manufacturers continually introduce faster and more expensive hardware into succeeding generations of printing devices. Therefore, each new generation of printer tends to have faster and more expensive CPUs, data/instruction buses, memory, ASICs and the like. Printer manufacturers generally accept the notion that the fastest, largest capacity and most costly components will be required to improve printer performance in succeeding generations of printing devices.

Accordingly, the need exists for a way to reduce printing delays and printing errors in printing devices without having to continually introduce faster, larger capacity and more expensive components.

### SUMMARY

A system and methods provide real-time printing that enables printing devices to begin outputting printed media directly upon activation of a print command. The system and methods generally perform preprocessing of a printable document while the document is being created.

As a document is generated within an application program, a real-time print driver executes to continually process newly available document information. Each newly introduced piece of document information is preprocessed as a fractional print job formatted in a page description language appropriate for an associated printing device. Fractional print jobs can be stored on the host computer or on the printing device after being rendered as raster data. When a user activates a print command from within the application program, the printing device begins printing the document directly from the preprocessed stored document information.

In one embodiment, document information is converted into fractional print jobs that are transferred to an associated printing device. Fractional print jobs are rendered as raster bits that are stored in groups such as raster strips or raster patches. Each raster group represents part of a growing raster page. Preprocessed raster pages stored on the printing device are printed on print media immediately upon activation of a print command. In this embodiment, preprocessing includes converting document information into a page description language in addition to rendering the document information into raster data.

In another embodiment, document information is converted into fractional print jobs that are stored on the host computer. Each fractional print job represents a portion of a growing print job that is stored on the host computer. When a print command is activated, the print job is transferred to a printing device where it is rendered as raster data and printed. In this embodiment, preprocessing includes converting document information into a page description language and storing it on a host computer.

In both embodiments, an alteration to part of a document already preprocessed results in reprocessing only the part of the document that is altered. A fractional print job that includes the altered section of the document is processed as discussed in the above embodiments.

### BRIEF DESCRIPTION OF THE DRAWINGS

The same reference numbers are used throughout the drawings to reference like components and features.

FIG. 1 illustrates a system environment that is suitable for real-time printing.

FIG. 2 is a block diagram illustrating in greater detail, an exemplary embodiment of a host computer and printing device such as those shown in FIG. 1 .

FIG. 3 is a flow diagram illustrating an example method of real-time printing.

FIG. 4 is a flow diagram illustrating an alternate example method of real-time printing.

### DETAILED DESCRIPTION

The system and methods described herein relate to printing a document in real-time. That is, upon activation of a print command, a printing device can immediately begin moving print media and output printed material. Rather than requiring printing resources to process a document all at once, the system and methods spread processing demands out over the duration of the document's composition. Advantages of the disclosed system and methods include reduced or nonexistent delay times between the activation of a print command and the initiation of printed output and a reduction in printing failures.

### Exemplary System Environment For Real-Time Printing

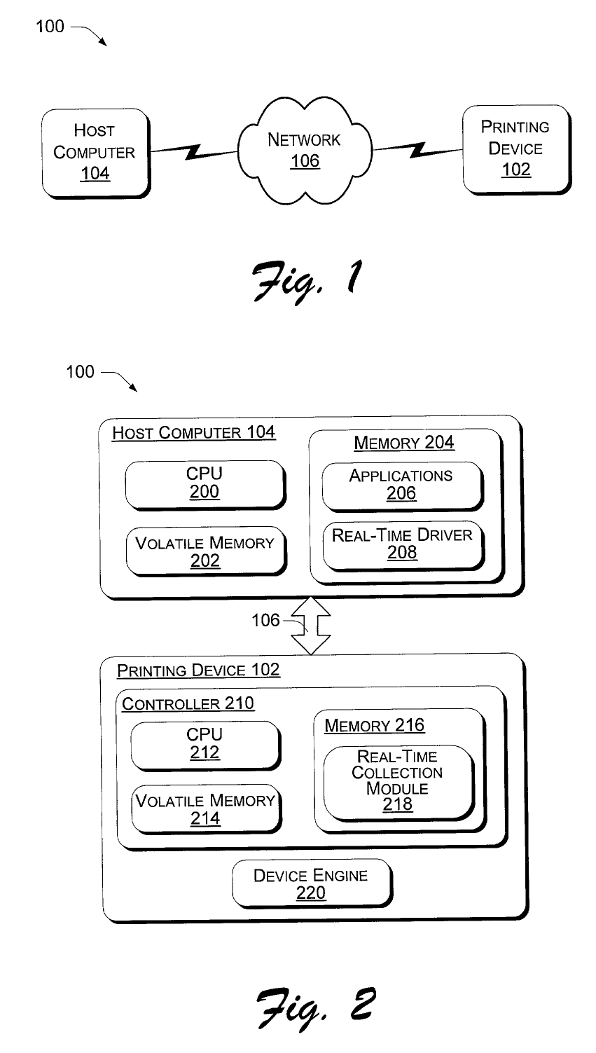

FIG. 1 illustrates an exemplary system environment that is suitable for real-time printing. The exemplary system environment 100 of FIG. 1 includes printing device 102 operatively coupled to a host computer 104 through a direct or network connection 106. The direct or network connection 106 can include, for example, a printer cable, a LAN (local area networks), a WAN (wide area networks), an intranet, the Internet, or any other suitable communication link.

This disclosure is applicable to various types of printing devices 102 capable of rendering PDL (page description language) data in printed form on a print medium, such as printing pixels on paper. Therefore, printing device 102 can include devices such as laser-based printers, ink-based printers, dot matrix printers, dry medium printers, plotters and the like. In addition, printing device 102 can include various multi-function peripheral (MFP) devices that combine a printing function with other functions such as faxing, scanning, copying and the like.

Host computer 104 can be implemented as a variety of general purpose computing devices including, for example, a personal computer (PC), a server, a Web server, and other devices configured to communicate with printing device 102. Host computer 104 typically provides a user with the ability to manipulate or otherwise prepare in electronic form, an image or document to be rendered as an image that is printed or otherwise formed onto a print medium by printing device 102 after transmission over network 106. In general, host computer 104 outputs host data to printing device 102 in a driver format suitable for the device 102, such as PCL or PostScript. Printing device 102 converts the host data and outputs it onto an appropriate recording media, such as paper or transparencies.

### Exemplary System Embodiments For Real-Time Printing

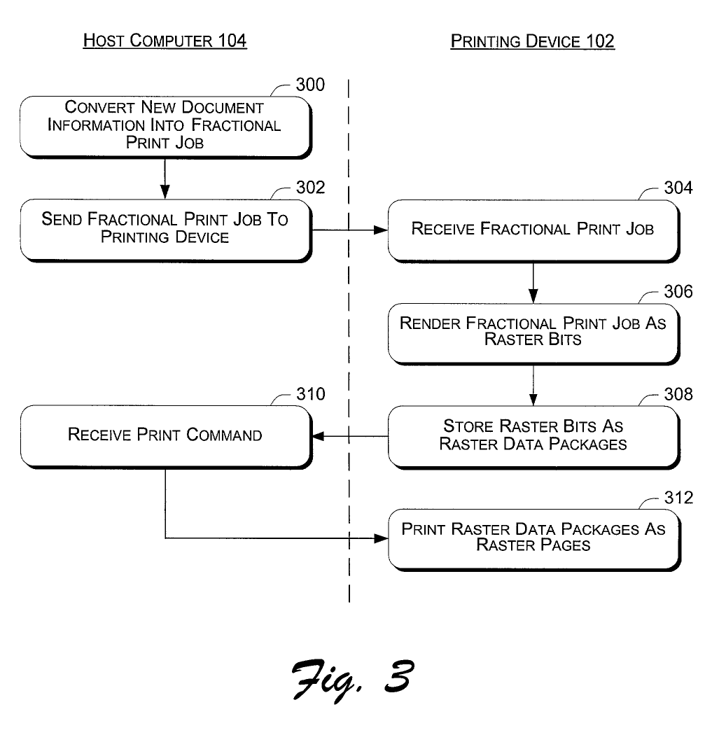

FIG. 2 illustrates an exemplary embodiment of the system 100 in greater detail. Host computer 104 includes a processor 200, a volatile memory 202 (i.e., RAM), and a non-volatile memory 204 (e.g., ROM, hard disk, floppy disk, CD-ROM, etc.). Nonvolatile memory 204 generally provides storage of computer readable instructions, data structures, program modules and other data for host computer 104. Host computer 104 may implement various application programs 206 stored in memory 204 and executed on processor 200 that create a document or image (e.g., text and graphics) on a computer screen that is transferred to printing device 102 for creating a hard copy of the document/image. Such applications 206 might include software programs implementing word processors, illustrators, computer-aided design tools and the like.

Host computer 104 may also implement one or more software-based device drivers such as real-time driver 208 that are stored in non-volatile memory 204 and executed on processor 200. Device drivers might also be implemented on the specific devices they are “driving”. In general, a device driver such as real-time driver 208 formats document information into page description language (PDL) such as PostScript or Printer Control Language (PCL) or another appropriate format which it outputs to printing device 102. In addition, real-time driver 208 operates in various ways to facilitate preprocessing of document information in preparation for document printing as discussed more specifically herein below.

Printing device 102 has a controller 210 that processes data from host computer 104. The controller 210 typically includes a data processing unit or CPU 212, a volatile memory 214 (i.e., RAM), and a nonvolatile memory 216. Nonvolatile memory 216 can include various computer storage media such as ROM, flash memory, a hard disk, a removable floppy disk, a removable optical disk and the like. Nonvolatile memory 216 generally provides storage of computer readable instructions, data structures, program modules and other data for printing device 102.

In the exemplary embodiment of FIG. 2, printing device 102 also includes a real-time collection module 218 stored in memory 216. In general, real-time collection module 218 executes on processor 212 to format host computer 104 data and control the output of printing device 102 through printer device engine 220. In addition, real-time collection module 218 operates in conjunction with real-time driver 208 in various ways that facilitate preprocessing of document information in preparation for document printing as discussed more specifically herein below.

In a first instance of the exemplary embodiment of FIG. 2, real-time driver 208 facilitates a dialogue between printing device 102 and an application 206 while a user actively composes a document within the application 206. Real-time driver 208 converts or formats in real-time, each document event into a page description language (e.g., PostScript or Printer Control Language (PCL)) appropriate for a selected printing device 102. A document event includes any element that is newly introduced to a document as the document is composed within the application program 206. Therefore, a document event includes entering a character from a keyboard into a document, drawing a graphical mark within a document, pasting a graphical object into a document, changing a font within a document, adding a background within a document and the like. In addition, a document event can include any manner of loading a file into an application 206. Thus, opening up a pre-existing document file stored in a memory or downloading a document file over a network into an application 206 are both examples of document events that initiate the formatting of document information into a page description language by real-time driver 208.

Each converted or formatted document event represents a small print job that is a fractional constituent of the document being generated within an application 206. In the first instance of the exemplary embodiment of FIG. 2, real-time driver 208 transfers each fractional print job in real-time to printing device 102. A real-time collection module 218 receives each fractional print job and renders it into raster bits as a raster data package. Generally, raster bits drive a print engine to lay down dots or pixels onto a print medium (e.g., a page of paper) in a pattern that portrays a document composed within an application program 206. A raster data bit represents one dot or pixel to be printed on a print medium. A raster data package typically represents some portion of a raster strip or raster patch that includes many raster bits. Real-time collection module 218 stores raster data packages on printing device 102 as a growing raster page. As a document is being generated/composed within an application 206, real-time collection module 218 can store numerous raster pages, each representing a page of the document.

As indicated above, a document event includes any element that is newly introduced to a document as the document is composed within an application program 206. Therefore, document events that change during document composition are also processed in the same manner as described above by the real-time driver 208 and real-time collection module 218. Processing a changed document event does not, however, require reprocessing portions of the document that have already been processed. Only the changed event itself must be reprocessed. For example, if the composer of a document finishes the last page of the document and then decides to go back and change the title page, the real-time driver 208 and real-time collection module 218 process the changed document events as described above such that the appropriate raster bits are removed and/or altered.

When a user activates a print command from within an application 206, printing device 102 will immediately begin moving print media and printing raster pages that have been preprocessed in the manner just described.

In a second instance of the exemplary embodiment of FIG. 2, real-time driver 208 facilitates a dialogue between printing device 102 and an application 206 while a user actively composes a document within the application 206. Just as in the first instance described above, real-time driver 208 converts in real-time, each document event into a fractional print job formatted in a particular PDL appropriate for a selected printing device 102. Changes to document events are also handled in the same manner as described above.

In the second instance, real-time driver 208 stores each fractional print job on host computer 104 as a portion of a growing print job. The growing print job represents in a PDL format, the entire document up to the latest document event that has been introduced within application 206. When a user activates a print command from within the application 206, real-time driver 208 immediately begins transferring the print job to printing device 102 where the real-time collection module 218 renders it into raster data and begins printing raster pages onto a print medium.

### Exemplary Methods For Real-Time Printing

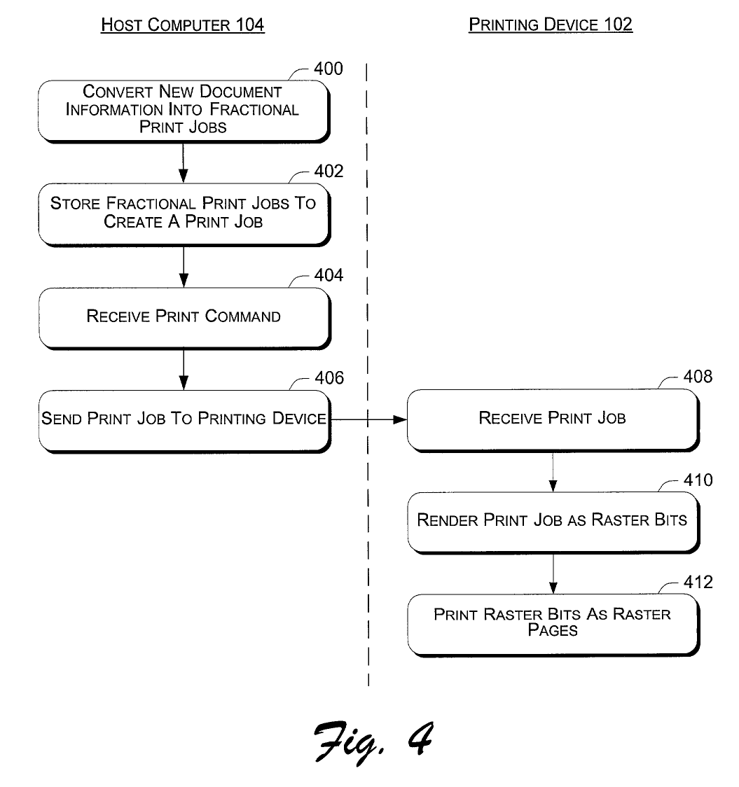

Example methods for real-time printing will now be described with primary reference to FIGS. 3 and 4. The methods apply generally to the exemplary embodiment of system 100 discussed above with reference to FIG. 2.

FIGS. 3 and 4 are flow diagrams that show examples of general methods for real-time printing. At block 300 of FIG. 3, newly generated document information is converted into a fractional print job on a host computer 104. The document information is typically generated from within an application program 206 executing on host computer 104. At block 302, the fractional print job is sent from the host computer 104 to a printing device 102. At block 304, the printing device 102 receives the fractional print job.

Upon receiving a fractional print job, printing device 102 renders the fractional print job to raster bits as shown in block 306. At block 308, printing device 102 stores the raster bits. Typically the raster bits are stored as raster data packages that eventually make up raster strips or raster patches. At block 310 a print command is received at host computer 104. At block 312, printing device 102 immediately begins printing stored raster data as raster pages onto a print medium.

FIG. 4 is a flow diagram illustrating an alternate example method of real-time printing. At block 400, newly generated pieces of document information are converted into fractional print jobs on a host computer 104. The document information is typically generated from within an application program 206 executing on host computer 104. At block 402, each fractional print job is stored on host computer 104. The fractional print jobs make up a growing print job being stored on host computer 104. At block 404 a print command is received at host computer 104. The print command is generated from within the application program 206. At block 406, the print job is sent to a printing device 102.

Upon receiving the print job at block 408, the printing device 102 renders it as raster bits at block 410. The raster bits are printed as raster pages on a print medium at block 412.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

1. A method for real-time printing comprising:
during generation of a document,
continually converting new document information into a fractional print job;
sending each fractional print job to a printer; and
rendering each fractional print job as a raster data package.

2. A method as recited in claim 1, further comprising storing each raster data package in a memory on the printer.

3. A method as recited in claim 2, further comprising forming a raster page from one or more raster data packages.

4. A method as recited in claim 3, further comprising:
after completion of the generation of document information,
printing the raster page.

5. A method as recited in claim 4, wherein the completion of the generation of document information comprises receiving an instruction to print the document information.

6. A method as recited in claim 1, wherein the converting further comprises formatting the fractional print job into a page description language.

7. A method as recited in claim 6, wherein the page description language is a language selected from a group of languages comprising:
Printer Control Language (PCL); and
PostScript.

8. A method as recited in claim 1, wherein the generation of document information comprises:
entering characters into a document;
transferring characters into the document;
drawing graphics into the document; and
downloading graphics into the document.

9. A computer-readable medium comprising computer executable instructions configured to cause a computer to perform the method of claim 1.

10. A method for real-time printing comprising:
during generation of a document,
continually converting new document information into a fractional printjob; and
storing each fractional print job to create a print job.

11. A method as recited in claim 10, further comprising:
receiving an instruction to print the document;
sending the print job to a printer; and
printing the print job.

12. A method as recited in claim 11, wherein the printing further comprises rendering the print job as raster data.

13. A method as recited in claim 10, wherein the converting further comprises formatting the fractional print job into a page description language.

14. A method as recited in claim 13, wherein the page description language is a language selected from a group of languages comprising:
Printer Control Language (PCL); and
PostScript.

15. A method as recited in claim 10, wherein the generation of a document comprises:
entering characters into the document;
transferring characters into the document;
drawing graphics into the document;
downloading graphics into the document; and
altering characteristics of the document.

16. A computer-readable medium comprising computer executable instructions configured to cause a computer to perform the method of claim 10.

17. A method for real-time printing comprising:
receiving fractional print jobs;
rendering each fractional print job as one or more raster data packages;
storing each raster data package.

18. A method as recited in claim 17, further comprising:
receiving a print instruction; and
printing all raster data packages.

19. A method as recited in claim 17, further comprising:
receiving an updated job designated to update a prior fractional print job;
rendering the updated job as one or more updated raster data packages; and
storing each updated raster data package.

20. A method as recited in claim 19, further comprising:
receiving a print instruction; and
printing all raster data packages.

21. A method as recited in claim 17, wherein the storing further comprising forming a raster page from raster data packages.

22. A computer-readable medium comprising computer executable instructions configured to cause a computer to perform the method of claim 17.

23. A printer comprising:
a processor;
a memory; and
a collection module executable on the processor to receive fractional print jobs, convert fractional print jobs into raster data packages, and store raster data packages as raster pages in the memory, each raster page comprising one or more raster data packages.

24. A computer comprising:
a processor;
a memory;
an application program executable on the processor to generate a document; and
a real-time driver configured to convert document information into fractional print jobs during generation of the document and send the fractional print jobs to a printer.

25. A system comprising:
a computer having a real-time driver, the real-time driver configured to continually convert newly generated document information into a fractional print job and to send each fractional print job to a printing device; and
the printing device having a collection module configured to receive each fractional print job, convert each fractional print job into one or more raster data packages, and store the one or more raster data packages;
wherein, upon receiving a print instruction from the computer, the printing device immediately begins printing raster data packages.

26. A system as recited in claim 25, wherein a fractional print job includes an updated fractional print job that represents a change made to previously generated document information.
